(19) United States
(12) Patent Application Publication
(10) Pub. No.: US 2021/0195697 A1
(43) Pub. Date: Jun. 24, 2021

(54) THIN FILM HEATER AND CAMERA LENS HAVING THE SAME

(71) Applicant: INDUSTRIAL TECHNOLOGY RESEARCH INSTITUTE, Hsinchu (TW)

(72) Inventors: Li-Wei YAO, Kaohsiung City (TW); Hsiao-Fen WEI, New Taipei City (TW); Yu-Ching LIN, Taichung City (TW); Yi-Rong LIN, Hsinchu City (TW); Kai-Ming CHANG, New Taipei City (TW); Yen-Shu LEE, Taoyuan City (TW)

(73) Assignee: INDUSTRIAL TECHNOLOGY RESEARCH INSTITUTE, Hsinchu (TW)

(21) Appl. No.: 16/791,612

(22) Filed: Feb. 14, 2020

(30) Foreign Application Priority Data
Dec. 20, 2019 (TW) 108146859

(51) Int. Cl. H05B 3/86; H05B 3/18

(52) U.S. Cl. CPC H05B 3/86; G03B 17/55; H05B 3/18

(57) ABSTRACT

A thin film heater includes a heat conductive layer, a heat insulation layer and a heat generation layer. The heat generation layer is disposed between the heat conductive layer and the heat insulation layer. The thermal conductivity of the heat conductive layer is greater than or equal to three times the thermal conductivity of the heat insulation layer.

### CROSS-REFERENCE TO RELATED APPLICATIONS

This non-provisional application claims priority under 35 U.S.C. § 119(a) on Patent Application No(s). 108146859 filed in Taiwan R.O.C. on Dec. 20, 2019, the entire contents of which are hereby incorporated by reference.

### BACKGROUND

### 1. Technical Field

This present disclosure relates to a thin film heater and a vehicle camera lens having the thin film heater.

### 2. Related Art

Advanced driver assistance system (ADAS) is one of key technologies in the development of intelligent vehicles, and ADAS can be incorporated with image sensor. Through image recognition and radar feedback information, the situation outside the vehicle can be analyzed in real time to enable drivers to take proactive actions, thereby preventing traffic accidents. A conventional ADAS is capable of detecting certain objects and performing basic classification to remind risk and danger on the road and, in some cases, even slow down or stop the vehicle. The ADAS is suitable for monitoring blind spots, assisting lanes change and providing forward collision warning.

Generally, an ADAS includes multiple image sensors in order to achieve monitoring around all perspectives of the vehicle. Since the ADAS is a dominant tool for automatic driving, its system reliability is very important for drivers. The ADAS should work normally when one drives the vehicle in wet and cold environment.

### SUMMARY

According to one embodiment of the present disclosure, a thin film heater includes a heat conductive layer, a heat insulation layer and a heat generation layer. The heat generation layer is disposed between the heat conductive layer and the heat insulation layer. The thermal conductivity of the heat conductive layer is greater than or equal to three times the thermal conductivity of the heat insulation layer.

According to another embodiment of the present disclosure, a camera lens, includes a cover glass and the aforementioned thin film heater. The thin film heater is in thermal contact with the cover glass.

### BRIEF DESCRIPTION OF THE DRAWINGS

FIG. 1 is a schematic view of a thin film heater according to a first embodiment of the present disclosure;

FIG. 2A is a schematic view of a thin film heater according to a second embodiment of the present disclosure;

FIG. 2B is a schematic view showing bent thin film heater in FIG. 2A;

FIG. 3 is a schematic view of a thin film heater according to a third embodiment of the present disclosure;

FIG. 4 is a schematic view of a thin film heater according to a fourth embodiment of the present disclosure;

FIG. 5 is a schematic view of a thin film heater according to a fifth embodiment of the present disclosure;

FIG. 6 is a schematic view of a thin film heater according to a sixth embodiment of the present disclosure;

FIG. 7 is a schematic view of a thin film heater according to a seventh embodiment of the present disclosure;

FIG. 8 is a schematic view of a thin film heater according to an eighth embodiment of the present disclosure;

FIG. 9 is a schematic view of a thin film heater according to a ninth embodiment of the present disclosure;

FIG. 10 is a schematic view of a thin film heater according to a tenth embodiment of the present disclosure;

FIG. 11 is a schematic view of a thin film heater according to an eleventh embodiment of the present disclosure;

FIG. 12 is a schematic view of a thin film heater according to a twelfth embodiment of the present disclosure;

FIG. 13 is a schematic view of a thin film heater according to a thirteenth embodiment of the present disclosure; and

FIG. 14 is a schematic view of a vehicle camera lens according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

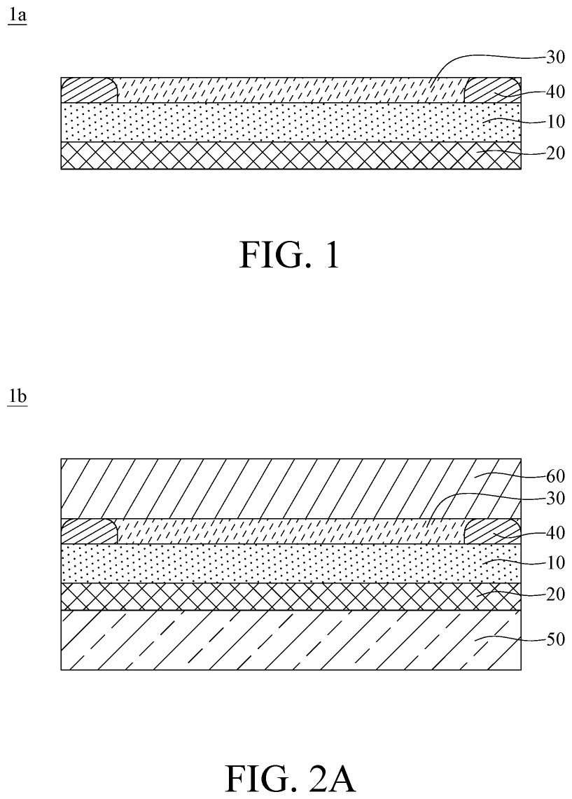

According to one embodiment of the present disclosure, thin film heater includes a heat conductive layer, a heat insulation layer and a heat generation layer. Please refer to FIG. 1 showing a schematic view of a thin film heater according to a first embodiment of the present disclosure. In this embodiment, a thin film heater 1a includes a heat generation layer 10, a heat conductive layer 20, a heat insulation layer 30 and a patterned electrode 40.

The heat generation layer 10 is made of, for example but not limited to, indium tin oxide (ITO), indium oxide (In₂O₃), tin oxide (SnO₂), zinc oxide (ZnO), cadmium oxide (CdO), cadmium-indium oxide (CdIn₂O₄), cadmium-tin oxide (Cd₂SnO₄), tin-zinc oxide (Zn₂SnO₄), aluminum doped zinc oxide (AZO), gallium doped zinc oxide (GZO), or indium doped zinc oxide (IZO), and heat generation layer 10 has a sheet resistance of 45±20Ω/□. The heat conductive layer 20 is made of, for example but not limited to, titanium oxide, aluminum oxide, magnesium oxide or silicon oxide, and the heat conductive layer 20 is disposed on one side of the heat generation layer 10. The heat conductive layer 20 can be in thermal contact with any element (not shown in the drawings) needed to be heated, and heat generated by the heat generation layer 10 is transferred to the element by the heat conductive layer 20. The element needed to be heated can be, for example, a cover glass in a vehicle camera lens or a car window.

The heat insulation layer 30, for example but not limited to, silicon oxide or tantalum nitride disposed on another side of the heat generation layer 10, such that the heat generation layer 10 is between the heat conductive layer 20 and the heat insulation layer 30. The heat insulation layer 30 has lower thermal conductivity than the heat generation layer 10, and it is favorable for most amount of heat generated by the heat generation layer 10 being transferred via the heat conductive layer 20, such that the thin film heater 1a enjoys single directional heat conduction. In one embodiment, the thermal conductivity of the heat conductive layer 20 is greater than or equal to three times the thermal conductivity of the heat insulation layer 30; thus, the heat generated by the heat generation layer 10 tends to flow through the heat conductive layer 20 more easily, and does not tend to flow toward the heat insulation layer 30. The thermal conductivity of the heat conductive layer 20 can be greater than or equal to 30.0 W/mK, and the thermal conductivity of the heat insulation layer 30 can be less than or equal to 10 W/mK. For example, in this embodiment, the thermal conductivity of the heat conductive layer 20 is from 30.0 W/mK to 90.0 W/mK, and the thermal conductivity of the heat insulation layer 30 is from 0.84 W/mK to 10.0 W/mK.

The patterned electrode 40, for example but not limited to, a metal pad disposed on the surface of the heat generation layer 10. The patterned electrode 40 may include electrically conductive material such as gold, silver, copper, aluminum, cast iron, steel, graphite, brass, red copper, copper-silver alloy and aluminum alloy. The patterned electrode 40 can be connected with external power source (not shown in the drawings) for introducing electric current into the heat generation layer 10, thereby achieving electric heating to the heat generation layer 10.

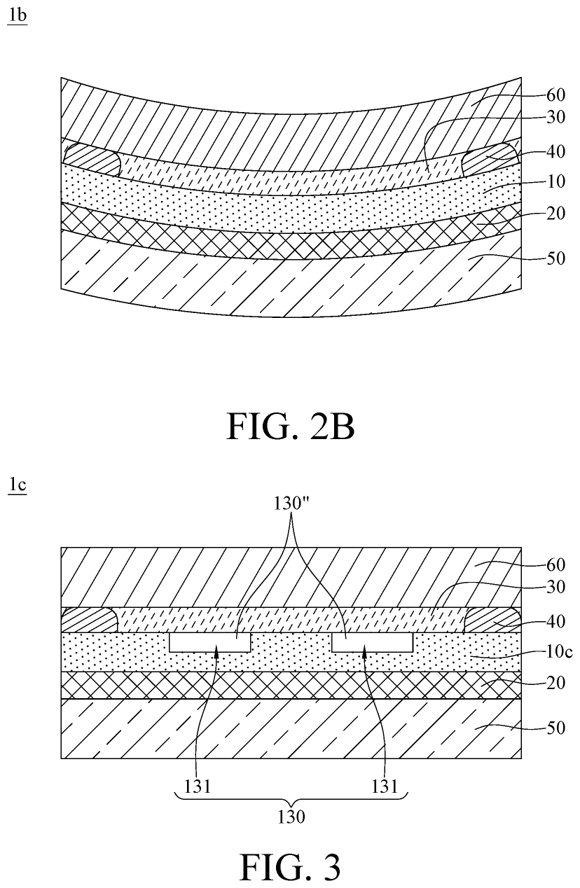

According to one embodiment of the present disclosure, thin film heater further includes a protective layer and a substrate. Please refer to FIG. 2A and FIG. 2B. FIG. 2A is a schematic view of a thin film heater according to a second embodiment of the present disclosure, and FIG. 2B is a schematic view showing bent thin film heater in FIG. 2A. In this embodiment, a thin film heater 1b includes a heat generation layer 10, a heat conductive layer 20, a heat insulation layer 30, a patterned electrode 40, a substrate 50 and a protective layer 60. As to the heat generation layer 10, the heat conductive layer 20, the heat insulation layer 30 and the patterned electrode 40, any description of these elements can be referred to the aforementioned content related to the thin film heater 1a in FIG. 1, and such description is not repeated hereafter.

The substrate 50 is made of, for example but not limited to, polyimide (PI). In one embodiment, the substrate 50 can be made of colorless polyimide (CPI). The substrate 50 is disposed on one side of the heat conductive layer 20, and the heat conductive layer 20 is located between the heat generation layer 10 and the substrate 50. The substrate 50 can be taken as a base for deposition of the heat conductive layer 20 during fabrication of the thin film heater 1b. The protective layer 60 is, for example but not limited to, a hard coating (HC) disposed on one side of the heat insulation layer 30, and the heat insulation layer 30 is located between the heat generation layer 10 and the protective layer 60.

In this embodiment, the thickness of the heat insulation layer 30 is less than or equal to four times of the thickness of the heat conductive layer 20. A total thickness of the heat insulation layer 30 and the protective layer 60 can be less than or equal to four times of a total thickness of the heat conductive layer 20 and the substrate 50. Therefore, the thin film heater 1b can be bent (as shown in FIG. 2B) to be applicable to a curved heated object.

According to one embodiment of the present disclosure, a heat isolation layer is disposed on one side the heat generation layer facing toward the heat insulation layer. Please refer to FIG. 3 showing a schematic view of a thin film heater according to a third embodiment of the present disclosure. In this embodiment, a thin film heater 1c includes a heat generation layer 10c, a heat conductive layer 20, a heat insulation layer 30, a patterned electrode 40, a substrate 50 and a protective layer 60. As to these elements mentioned above, any description can be referred to the aforementioned content related to the thin film heater in FIG. 1 and FIG. 2A, and such description is not repeated hereafter.

In this embodiment, the heat generation layer 10c is located between the heat conductive layer 20 and the heat insulation layer 30, and a recess 130 is formed on the surface of the heat generation layer 10c facing toward the heat insulation layer 30, and a heat isolation layer 130″ is disposed in the recess 130. The heat isolation layer 130″ includes medium with low thermal conductivity, such as air, inorganic porous material (e.g., foam glass and calcium silicate), foam organic polymer (e.g., polyurethane (PU) with fluorocarbon gas, foam rubber, foam polyurethane), aerogel, hollow glass particles, rock wool, glass fibers and porous silicone. It is worth noting that the present disclosure is not limited to these exemplary heat isolation layer. In this embodiment, the patterned recess 130 is formed on the surface of the heat generation layer 10c, and the recess 130 in FIG. 3 has multiple channels 131 communicated with each other. The heat isolation layer 130″ is favorable for increasing heat resistance between the heat insulation layer 30 and the heat generation layer 10c so as to prevent heat generated by the heat generation layer 10c from being transferred into the heat insulation layer 30. The recess is not limited to the specific examples mentioned above. In other embodiments, multiple independent recesses can be formed on the surface of the heat generation layer, and the heat isolation layer is disposed in each recess.

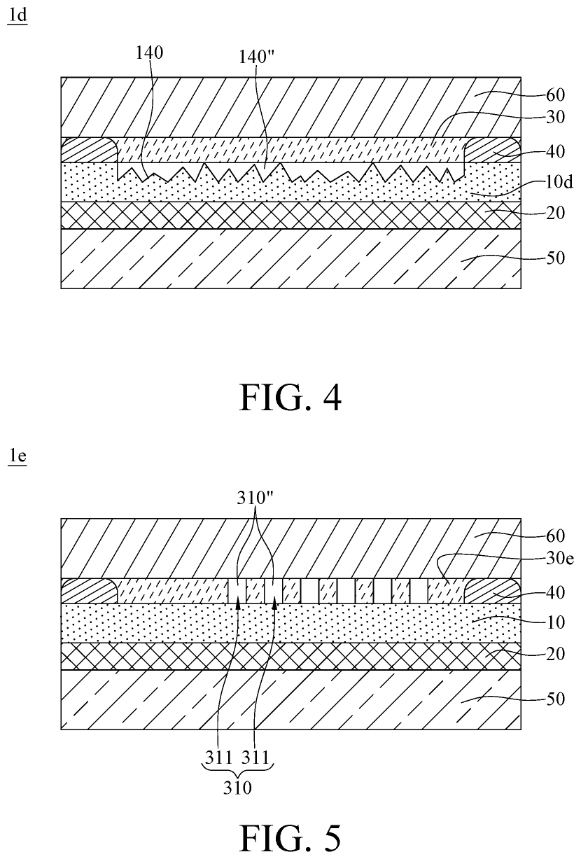

It is worth noting that the present disclosure is not limited to the heat isolation layer in FIG. 3. Please refer to FIG. 4 showing a schematic view of a thin film heater according to a fourth embodiment of the present disclosure. In this embodiment, a thin film heater 1d includes a heat generation layer 10d, a heat conductive layer 20, a heat insulation layer 30, a patterned electrode 40, a substrate 50 and a protective layer 60. As to these elements mentioned above, any description can be referred to the aforementioned content related to the thin film heaters 1a, 1b in FIG. 1 and FIG. 2A, and such description is not repeated hereafter. In this embodiment, the heat generation layer 10d is disposed between the heat conductive layer 20 and the heat insulation layer 30, and the heat generation layer 10d has a rough surface 140 facing toward the heat insulation layer 30. A heat isolation layer 140″ is disposed on the rough surface 140; one or more gaps are formed between the rough surface 140 and the heat insulation layer 30, and the heat isolation layer 140″ is disposed in the gap. The heat isolation layer 140″ includes medium with low thermal conductivity, such as air, inorganic porous material, foam organic polymer, aerogel, hollow glass particles, rock wool, glass fibers and porous silicone.

According to one embodiment of the present disclosure, the heat isolation layer is disposed between the protective layer and the heat generation layer. Please refer to FIG. 5 showing a schematic view of a thin film heater according to a fifth embodiment of the present disclosure. In this embodiment, thin film heater 1e includes a heat generation layer 10, a heat conductive layer 20, a heat insulation layer 30e, a patterned electrode 40, a substrate 50 and a protective layer 60. As to these elements mentioned above, any description can be referred to the aforementioned content related to the thin film heaters in FIG. 1 and FIG. 2A, and such description is not repeated hereafter. In this embodiment, the heat insulation layer 30e is disposed on one side of the heat generation layer 10, and the heat insulation layer 30e has a through-hole structure 310 penetrating through the heat insulation layer 30e. The heat isolation layer 310″ is disposed in the through-hole structure 310. The through-hole structure 310 includes multiple through holes 311, and the heat isolation layer 310″ in the through-hole structure 310 is located between the protective layer 60 and the heat generation layer 10. The heat isolation layer 310″ includes medium with low thermal conductivity, such as air, inorganic porous material, foam organic polymer, aerogel, hollow glass particles, rock wool, glass fibers and porous silicone. The through holes 311 of the through-hole structure 310 are communicated with each other in this embodiment, but the present disclosure is not limited thereto. In other embodiments, multiple independent through holes can be formed in the heat insulation layer, and the heat isolation layer is disposed in each through hole.

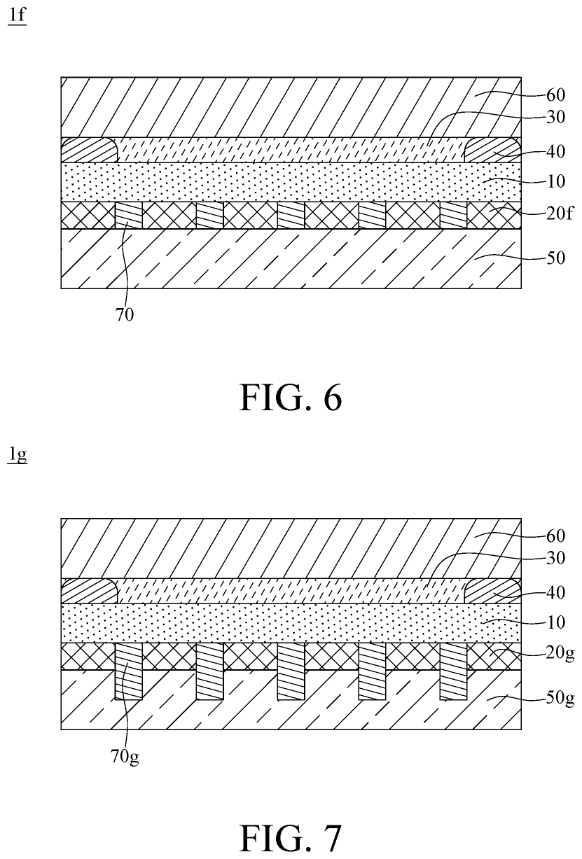

According to one embodiment of the present disclosure, the thin film heater includes a heat transfer structure. Please refer to FIG. 6 showing a schematic view of a thin film heater according to a sixth embodiment of the present disclosure. In this embodiment, thin film heater 1f includes a heat generation layer 10, a heat conductive layer 20f, a heat insulation layer 30, a patterned electrode 40, a substrate 50 and a protective layer 60. As to these elements mentioned above, any description can be referred to the aforementioned content related to the thin film heaters 1a, 1b in FIG. 1 and FIG. 2A, and such description is not repeated hereafter. In this embodiment, a thin film heater if further includes a heat transfer structure 70 disposed in the heat conductive layer 20f. The heat transfer structure 70 is a patterned metal layer extending into the heat conductive layer 20f. The heat transfer structure 70 penetrates through the heat conductive layer 20f and contacts the heat generation layer 10 and the substrate 50. A configuration including the heat conductive layer 20f and the heat transfer structure 70 is favorable for enhancing thermal conductivity, such that heat generated by the heat generation layer 10 is transferred toward the substrate 50 more easily via the heat conductive layer 20f and the heat transfer structure 70. It is worth noting that the present disclosure is not limited to the heat transfer structure in FIG. 6. In other embodiments, the heat transfer structure may include multiple metal nanowires or metal nanoparticles dispersed in heat conductive layer or spread on the surface of the heat conductive layer. The heat transfer structure 70 is made of, for example but not limited to, gold, silver, copper, aluminum, aluminum ally, manganese, graphite or carbon fiber. Moreover, the heat transfer structure 70 may be in a form of, for example, pillar, sheet, scale, sphere, powder, long fiber, short fiber, whisker crystal, nanowire or nanoparticle.

According to one embodiment of the present disclosure, the heat transfer structure extends from the heat conductive layer into the substrate. Please refer to FIG. 7 showing a schematic view of a thin film heater according to a seventh embodiment of the present disclosure. In this embodiment, a thin film heater 1g includes a heat generation layer 10, a heat conductive layer 20g, a heat insulation layer 30, a patterned electrode 40, a substrate 50g, a protective layer 60 and a heat transfer structure 70g. As to these elements mentioned above, any description can be referred to the aforementioned content related to the thin film heaters 1b, if in FIG. 2A and FIG. 6, and such description is not repeated hereafter. The heat transfer structure 70g is disposed in the heat conductive layer 20g. In this embodiment, the heat transfer structure 70g is a patterned metal layer extending into the heat conductive layer 20g. The heat transfer structure 70g penetrates through the heat conductive layer 20 and further extends from the heat conductive layer 20g into the substrate 50g, such that an effect of the heat transfer structure 70g to the enhancement of thermal conductivity is more obvious.

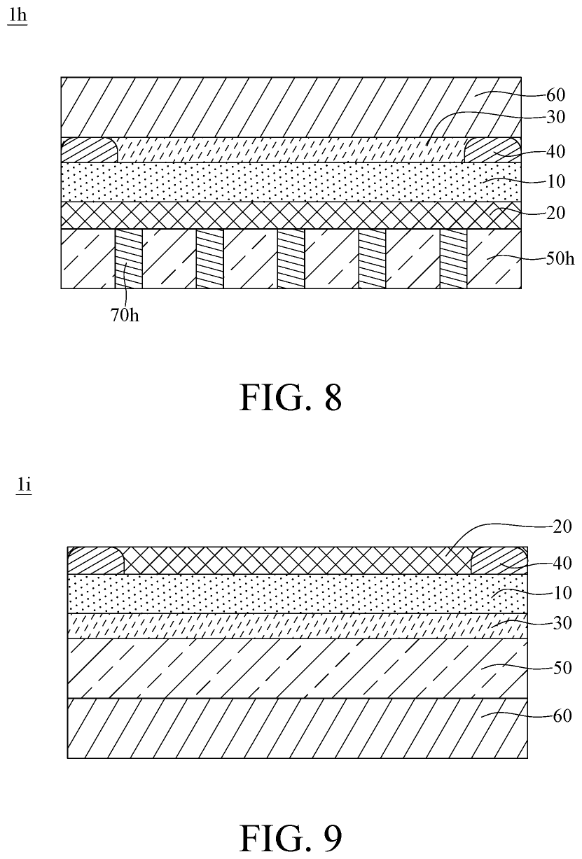

According to one embodiment of the present disclosure, the heat transfer structure is disposed in the substrate. Please refer to FIG. 8 showing a schematic view of a thin film heater according to an eighth embodiment of the present disclosure. In this embodiment, a thin film heater 1h includes a heat generation layer 10, a heat conductive layer 20, a heat insulation layer 30, a patterned electrode 40, a substrate 50h, a protective layer 60 and a heat transfer structure 70h. As to these elements mentioned above, any description can be referred to the aforementioned content related to the thin film heaters 1b, if in FIG. 2A and FIG. 6, and such description is not repeated hereafter. In this embodiment, the heat transfer structure 70h is disposed in the substrate 50h. The heat transfer structure 70h penetrates through the substrate 50h and contacts the heat conductive layer 20. The heat transfer structure 70h extends into the substrate 50h so as to be favorable for transferring heat from the heat conductive layer 20 toward the substrate 50h.

In FIG. 2A through FIG. 8, the protective layer 60 is disposed in one side of the heat insulation layer 30, but the present disclosure is not limited thereto. Please refer to FIG. 9 showing a schematic view of a thin film heater according to a ninth embodiment of the present disclosure. In this embodiment, a thin film heater 1i includes a heat generation layer 10, a heat conductive layer 20, a heat insulation layer 30, a patterned electrode 40, a substrate 50 and a protective layer 60. As to these elements mentioned above, any description can be referred to the aforementioned content related to the thin film heaters 1a, 1b in FIG. 1 and FIG. 2A, and such description is not repeated hereafter.

In this embodiment, the heat insulation layer 30 is disposed between the heat generation layer 10 and the substrate 50, and the substrate 50 is disposed between the heat insulation layer 30 and the protective layer 60. Herein, the substrate 50 is taken as a base for deposition of the heat insulation layer 30 during fabrication of the thin film heater 1i.

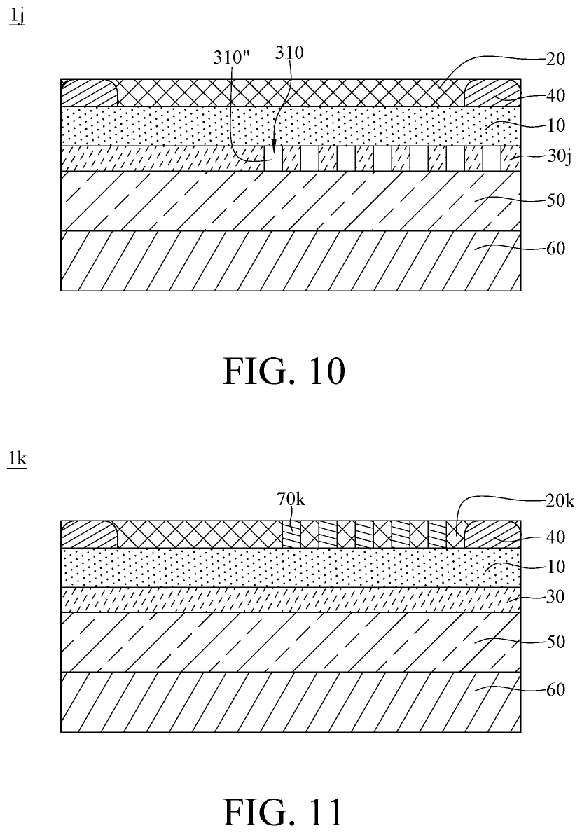

According to one embodiment of the present disclosure, a heat isolation layer is provided between the substrate and the heat generation layer. Please refer to FIG. 10 showing a schematic view of a thin film heater according to a tenth embodiment of the present disclosure. In this embodiment, a thin film heater 1j includes a heat generation layer 10, a heat conductive layer 20, a heat insulation layer 30j, a patterned electrode 40, a substrate 50 and a protective layer 60. As to these elements mentioned above, any description can be referred to the aforementioned content related to the thin film heaters 1b, 1i in FIG. 2A and FIG. 9, and such description is not repeated hereafter. In this embodiment, the heat insulation layer 30j has a through-hole structure 310 penetrating through the heat insulation layer 30j, and the heat isolation layer 310″ is disposed in the through-hole structure 310. The heat isolation layer 310″ is located between the substrate 50 and the heat generation layer 10. The function of the heat isolation layer 310″ can be referred to the aforementioned content related to the thin film heaters 1c, 1e in FIG. 3 and FIG. 5, and such description is not repeated hereafter.

Please refer to FIG. 11 showing a schematic view of a thin film heater according to an eleventh embodiment of the present disclosure. In this embodiment, a thin film heater 1k includes a heat generation layer 10, a heat conductive layer 20k, a heat insulation layer 30, a patterned electrode 40, a substrate 50 and a protective layer 60. As to these elements mentioned above, any description can be referred to the aforementioned content related to the thin film heaters 1b, 1i in FIG. 2A and FIG. 9, and such description is not repeated hereafter. In this embodiment, thin film heater 1k further includes a heat transfer structure 70k. The heat transfer structure 70k is a patterned metal layer extending into the heat conductive layer 20k. The heat transfer structure 70k penetrates through the heat conductive layer 20k and contacts one side of the heat generation layer 10 away from the heat insulation layer 30. Examples and function of the heat transfer structure 70k can be referred to the thin film heaters 1f, 1g in FIG. 6 and FIG. 7, and such description is not repeated hereafter.

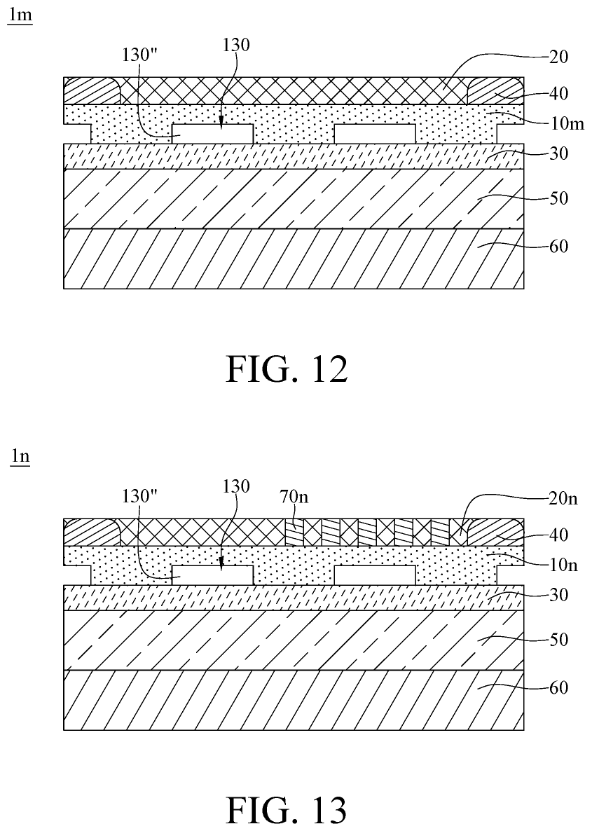

Please refer to FIG. 12 showing a schematic view of a thin film heater according to a twelfth embodiment of the present disclosure. In this embodiment, a thin film heater 1 m includes a heat generation layer 10 m, a heat conductive layer 20, a heat insulation layer 30, a patterned electrode 40, a substrate 50 and a protective layer 60. As to these elements mentioned above, any description can be referred to the aforementioned content related to the thin film heaters 1b, 1i in FIG. 2A and FIG. 9, and such description is not repeated hereafter. In this embodiment, a recess 130 is formed on the surface of the heat generation layer 10 m facing toward the heat insulation layer 30, and a heat isolation layer 130″ is disposed in the recess 130.

The heat isolation layer can work with heat transfer structure to make the improvement of heat conduction more obvious. Please refer to FIG. 13 showing a schematic view of a thin film heater according to a thirteenth embodiment of the present disclosure. In this embodiment, a thin film heater 1n includes a heat generation layer 10n, a heat conductive layer 20n, a heat insulation layer 30, a patterned electrode 40, a substrate 50, a protective layer 60 and a heat transfer structure 70n. As to these elements mentioned above, any description can be referred to the aforementioned content related to the thin film heaters 1a, 1b, 1k in FIG. 1, FIG. 2A and FIG. 11, and such description is not repeated hereafter. In this embodiment, a recess 130 is formed on the surface of the heat generation layer 10n facing toward the heat insulation layer 30, and a heat isolation layer 130″ is disposed in the recess 130. Furthermore, the heat transfer structure 70n is a patterned metal layer extending into the heat conductive layer 20n. The heat transfer structure 70n penetrates through the heat conductive layer 20n and contacts the heat generation layer 10n. Therefore, the thin film heater 1n includes the heat isolation layer 130″ as well as the heat transfer structure 70n in this embodiment, such that heat generated by the heat generation layer 10n is transferred toward the heat conductive layer 20n more easily; also, it is favorable for preventing heat from being transferred toward the heat insulation layer 30, thereby achieving single directional heat conduction.

According to the present disclosure, the aforementioned features of the thin film heater can be utilized in numerous combinations so as to achieve corresponding effects.

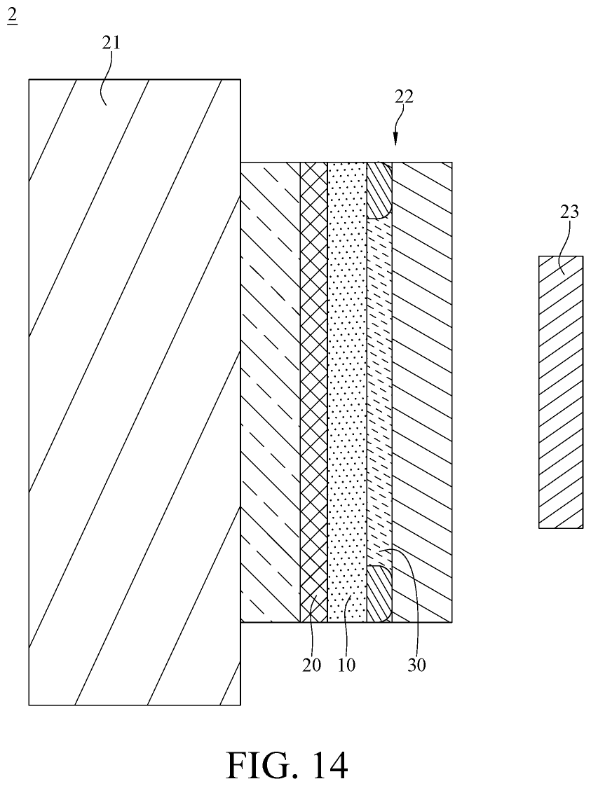

The thin film heater disclosed in the disclosure is applicable to vehicle camera lens. FIG. 14 is a schematic view of a vehicle camera lens according to one embodiment of the present disclosure. In this embodiment, a camera lens 2 includes a cover glass 21, a thin film heater 22 and an optical sensor 23. The cover glass 21, for example but not limited to, is a tempered glass plate exposing to outside, and the cover glass 21 is configured to prevent moisture or impact by external forces on optical elements. The thin film heater 22 can be considered as a thin film heater disclosed in any one of aforementioned embodiments, and the thin film heater 22 is in thermal contact with the cover glass 21. The optical sensor 23 is disposed on one side of the thin film heater 22 opposite to the cover glass 21. External light can travel through the cover glass 21 and thin film heater 22 to reach the optical sensor 23.

When the optical sensor 23 is provided for receiving visible light, each layer of the thin film heater 22 can be made of material which visible light is able to pass through. In detail, take the thin film heater 1a in FIG. 1 and as example, the heat generation layer 10, the heat conductive layer 20 and the heat insulation layer 30 are made of visible-light transmittable material, or these layers have small thickness to allow transmittance of visible light. In contrast, when the optical sensor 23 is provided for receiving non-visible light, each layer of the thin film heater 22 can be made of opaque material. Specifically, when the optical sensor 23 is provided for receiving infrared light, the heat generation layer 10, the heat conductive layer 20 and the heat insulation layer 30 of the thin film heater 1a in FIG. 1 are made of infrared-light transmittable material.

According to the present disclosure, the thin film heater includes a multilayer structure containing heat conductive layer, heat insulation layer and heat generation layer. The heat conductive layer has a higher thermal conductivity than the heat insulation layer; more specifically, the thermal conductivity of the heat conductive layer is greater than or equal to three times that of the heat insulation layer. Therefore, most amount of heat generated by the heat generation layer is transferred via the heat conductive layer 20, such that it is favorable for single directional heat conduction of the thin film heater.

Furthermore, according to the present disclosure, the camera lens applicable to vehicle includes cover glass and thin film heater in thermal contact with each other. When the moisture/water vapor existing in wet and cold environment condenses onto the cover glass, the thin film heater heats the cover glass to remove condensed water or moisture/water vapor. Since the thin film heater enjoys single directional heat conduction, heat flows to the cover glass via the heat conductive layer more easily so as to improve the efficiency of moisture/water vapor removal.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A thin film heater, comprising:
a heat conductive layer;
a heat insulation layer; and
a heat generation layer disposed between the heat conductive layer and the heat insulation layer;
wherein a thermal conductivity of the heat conductive layer is greater than or equal to three times a thermal conductivity of the heat insulation layer.

2. The thin film heater according to claim 1, wherein a sheet resistance of the heat generation layer is 45±20Ω/□.

3. The thin film heater according to claim 1, wherein a heat isolation layer is disposed on one side the heat generation layer facing toward the heat insulation layer.

4. The thin film heater according to claim 3, wherein a recess is located on a surface of the heat generation layer facing toward the heat insulation layer, and the heat isolation layer is disposed in the recess.

5. The thin film heater according to claim 3, wherein a rough surface of the heat generation layer faces toward the heat insulation layer, and the heat isolation layer is disposed on the rough surface.

6. The thin film heater according to claim 1, wherein a heat isolation layer is disposed in a through-hole structure of the heat insulation layer.

7. The thin film heater according to claim 6, further comprising a protective layer, wherein the heat insulation layer is disposed between the protective layer and the heat generation layer, the heat isolation layer is disposed between the protective layer and the heat generation layer.

8. The thin film heater according to claim 6, further comprising a substrate, wherein the heat insulation layer is disposed between the heat generation layer and the substrate, and the heat isolation layer is disposed between the substrate and the heat generation layer.

9. The thin film heater according to claim 1, further comprising a heat transfer structure disposed in the heat conductive layer.

10. The thin film heater according to claim 9, further comprising a substrate, wherein the heat conductive layer is disposed between the heat generation layer and the substrate, the heat transfer structure is a metal layer extending into the heat conductive layer, the heat transfer structure penetrates through the heat conductive layer and contacts the heat generation layer and the substrate.

11. The thin film heater according to claim 10, wherein the heat transfer structure extends from the heat conductive layer into the substrate.

12. The thin film heater according to claim 9, wherein the heat transfer structure is a metal layer extending into the heat conductive layer, the heat transfer structure penetrates through the heat conductive layer and contacts the heat generation layer.

13. The thin film heater according to claim 9, wherein the heat transfer structure comprises metal nanowires or metal nanoparticles.

14. The thin film heater according to claim 1, further comprising a substrate and a heat transfer structure, wherein the heat conductive layer is disposed between the heat generation layer and the substrate, and the heat transfer structure is disposed in the substrate.

15. The thin film heater according to claim 14, wherein the heat transfer structure penetrates through the substrate and contacts the heat conductive layer.

16. The thin film heater according to claim 1, wherein a thickness of the heat insulation layer is less than or equal to four times a thickness of the heat conductive layer.

17. The thin film heater according to claim 1, wherein the heat generation layer, the heat insulation layer and the heat conductive layer are made of material which visible light is able to pass through.

18. The thin film heater according to claim 1, wherein the heat generation layer, the heat insulation layer and the heat conductive layer are made of material which infrared light is able to pass through.

19. The thin film heater according to claim 1, further comprising a patterned electrode disposed on a surface of the heat generation layer.

20. A camera lens, comprising:
a cover glass; and
the thin film heater according to claim 1, in thermal contact with the cover glass.
